(19) United States
(12) Patent Application Publication
(10) Pub. No.: US 2023/0379039 A1
(43) Pub. Date: Nov. 23, 2023

(54) WIRELESS COMMUNICATION APPARATUS, WIRELESS COMMUNICATION SYSTEM AND WIRELESS COMMUNICATION CONTROL METHOD

(71) Applicant: NEC Corporation, Tokyo (JP)

(72) Inventor: Takashi OKAWA, Tokyo (JP)

(73) Assignee: NeC Corporation, Tokyo (JP)

(21) Appl. No.: 18/197,390

(22) Filed: May 15, 2023

(30) Foreign Application Priority Data
May 19, 2022 (JP) 2022-082364

(51) Int. Cl. H04B 7/10; H04B 1/00; H04B 1/04

(52) U.S. Cl. CPC H04B 7/10; H04B 1/0057; H04B 1/0483

(57) ABSTRACT

A wireless communication apparatus provided with an antenna that transmits and receives signals; a polarization beam combiner that is connected to the antenna and that performs multiplexed transmission of polarized waves; a power combiner that is connected to the antenna, that functions as a combiner when transmitting and that functions as a duplexer when receiving; a switch circuit to which a transmission signal is input during transmission, from which a reception signal is output during reception, and which switches between a first path connecting the polarization beam combiner with the antenna and a second path connecting the power combiner with the antenna; and a processor that switches the switch circuit based on a reception power so as to switch between connection to the first path and the second path.

This application is based upon and claims the benefit of priority from Japanese patent application No. 2022-082364, filed May 19, 2022, the disclose of which is incorporated herein in its entirety by reference.

### TECHNICAL FIELD

The present disclosure relates to a wireless communication apparatus, a wireless communication system, and a wireless communication control method.

### BACKGROUND ART

In point-to-point communication between cellular telephone base stations, for example, using high frequency bands, it is required to ensure the propagation distances and to ensure communication quality even in poor propagation environments such as in rainy weather. In response thereto, with the technology described in Patent Document 1 (WO 2015/059980 A1), the reception power is measured, the transmission quality is determined based on the measured reception power, the rain status is determined based on the determined transmission quality, and clear-weather communication parameters or rain communication parameters are selected.

### SUMMARY

An example of an objective of the present disclosure is to provide a wireless communication apparatus, a wireless communication system, and a wireless communication control method and program.

According to an example of a first embodiment disclosed herein, the wireless communication apparatus is a wireless communication apparatus provided with an antenna that transmits and receives signals; a polarization beam combiner that is connected to the antenna and that performs multiplexed transmission of polarized waves; a power combiner that is connected to the antenna, that functions as a combiner during transmission and that functions as a duplexer during reception; a switch circuit to which a transmission signal is input when transmitting, from which a reception signal is output when receiving, and that switches between a first path connecting the polarization beam combiner with the antenna and a second path connecting the power combiner with the antenna; and a processor that switches the switch circuit based on a reception power so as to switch between connection to the first path and the second path.

According to an example of a second embodiment disclosed herein, the wireless communication system is a wireless communication system in which a first wireless communication apparatus and a second wireless communication apparatus are connected over a network, wherein the first wireless communication apparatus and the second wireless communication apparatus are each provided with an antenna that transmits and receives signals, a polarization beam combiner that is connected to the antenna and that performs multiplexed transmission of polarized waves, a power combiner that is connected to the antenna, that functions as a combiner when transmitting and that functions as a duplexer when receiving, a switch circuit to which a transmission signal is input during transmission, from which a reception signal is output during reception, and that switches between a first path connecting the polarization beam combiner with the antenna and a second path connecting the power combiner with the antenna, and a processor that switches the switch circuit based on a reception power so as to switch between connection to the first path and the second path; and the processor in the first wireless communication apparatus issues, to the second wireless communication apparatus, an instruction to increase the transmission power if the reception power in the first wireless communication apparatus has decreased, issues, to the first wireless communication apparatus and the second wireless communication apparatus, instructions to switch the switch circuit from the polarization beam combiner to the power combiner if the second wireless communication apparatus is currently set to a maximum power under apparatus specifications, and issues, to the second wireless communication apparatus, an instruction to increase the transmission power if the second wireless communication apparatus is not currently set to the maximum power under apparatus specifications.

According to an example of a third embodiment disclosed herein, the wireless communication control method is a wireless communication control method performed by a wireless communication apparatus provided with an antenna that transmits and receives signals, a polarization beam combiner that is connected to the antenna and that performs multiplexed transmission of polarized waves, a power combiner that is connected to the antenna, that functions as a combiner when transmitting and that functions as a duplexer when receiving, and a switch circuit to which a transmission signal is input during transmission, from which a reception signal is output during reception, and that switches between a first path connecting the polarization beam combiner with the antenna and a second path connecting the power combiner with the antenna; wherein the method includes switching the switch circuit based on a reception power so as to switch between connection to the first path and the second path.

According to an example of a fourth embodiment disclosed herein, the program is a program executed by a computer in a wireless communication apparatus provided with an antenna that transmits and receives signals, a polarization beam combiner that is connected to the antenna and that performs multiplexed transmission of polarized waves, a power combiner that is connected to the antenna, that functions as a combiner when transmitting and that functions as a duplexer when receiving, and a switch circuit to which a transmission signal is input during transmission, from which a reception signal is output during reception, and that switches between a first path connecting the polarization beam combiner with the antenna and a second path connecting the power combiner with the antenna; wherein the program makes the computer switch the switch circuit based on a reception power so as to switch between connection to the first path and the second path.

### BRIEF DESCRIPTION OF THE DRAWINGS

FIG. 1 is a diagram depicting an example of the minimum configuration of a wireless communication apparatus according to an embodiment.

FIG. 2 is a diagram depicting an example of the configuration of a wireless communication apparatus according to a first embodiment.

FIG. 3 is a diagram for explaining the case in which the wireless communication apparatus operates as a transmission apparatus during clear weather.

FIG. 4 is a diagram for explaining the case in which the wireless communication apparatus operates as a transmission apparatus during rainy weather.

FIG. 5 is a flow chart of a processing procedure when clear weather has changed to rainy weather according to an embodiment.

FIG. 6 is a flow chart of a processing procedure for switching a switch circuit when clear weather has changed to rainy weather according to an embodiment.

FIG. 7 is a flow chart of a processing procedure when rainy weather has changed to clear weather according to an embodiment.

FIG. 8 is a flow chart of a processing procedure for switching the switch circuit when rainy weather has changed to clear weather according to an embodiment.

FIG. 9 is a diagram indicating examples of evaluation results in an embodiment.

FIG. 10 is a diagram depicting an example of the configuration of a wireless communication apparatus according to a modified example.

FIG. 11 is a diagram indicating an example of atmospheric attenuation indicated in ITU-R P.838-3.

FIG. 12 is a diagram indicating an example of rain attenuation indicated in ITU-R P.838-3.

FIG. 13 is a diagram depicting an example of the configuration of a wireless communication apparatus in a comparative example.

### EXAMPLE EMBODIMENT

Though the present embodiment will be explained below, the embodiment below does not limit the embodiments that are claimed. Additionally, the full combination of characteristics explained in the embodiments is not necessarily essential to the solution.

### [Minimum Configuration Example of Wireless Communication Apparatus]

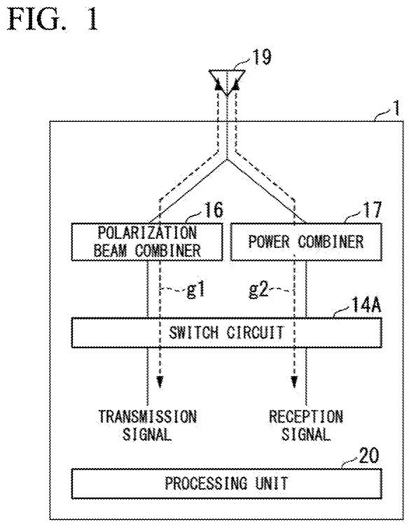

FIG. 1 is a diagram depicting an example of the minimum configuration of a wireless communication apparatus according to the present embodiment.

As in FIG. 1, the wireless communication apparatus 1 is provided with a switch circuit 14A, a polarization beam combiner 16, a power combiner 17, an antenna 19, and a processing unit 20 (hereinafter also referred to as “processor”).

The switch circuit 14A is connected to the polarization beam combiner 16 and the power combiner 17. The switch circuit 14A functions as a signal switching circuit to the polarization beam combiner 16 and the power combiner 17.

At the time of transmission, a transmission signal is input to the switch circuit 14A, and the switch circuit 14A outputs the transmission signal to the polarization beam combiner 16 or to the power combiner 17 in accordance with switching by the processing unit 20. At the time of reception, a reception signal is input to the switch circuit 14A from the polarization beam combiner 16 or the power combiner 17 in accordance with switching by the processing unit 20, and the switch circuit 14A outputs the transmission signal.

The polarization beam combiner 16 is connected to the switch circuit 14A and to the antenna 19. The polarization beam combiner 16 is an OMT (Ortho-Mode Transducer), and is used for multiplexed transmission of polarized waves.

The power combiner 17 is connected to the switch circuit 14A and to the antenna 19. The power combiner 17 is a hybrid device that can be either a combiner or a duplexer. The power combiner 17 functions as a combiner on the transmission side and functions as a duplexer on the reception side.

The antenna 19 is provided with two ports as inputs/outputs to/from the polarization beam combiner 16 and the power combiner 17.

The processing unit 20 switches the switch circuit 14A in accordance with the weather so as to switch the connected path between the polarization beam combiner 16 and the power combiner 17. The processing unit 20 determines the weather status, for example, based on the reception power in the local station (first wireless communication apparatus).

In this embodiment, the path connecting the polarization beam combiner 16 with the antenna 19 is referred to as the first path (double-headed arrow g1) and the path connecting the power combiner 17 with the antenna 19 is referred to as the second path (double-headed arrow g2).

In this way, the wireless communication apparatus 1 is provided with: an antenna 19 that transmits and receives signals; a polarization beam combiner 16 that is connected to the antenna 19 and that performs multiplexed transmission of polarized waves; a power combiner 17 that is connected to the antenna, that functions as a combiner during transmission and that functions as a duplexer during reception; a switch circuit 14A to which a reception signal is input during transmission, from which a reception signal is output during reception, and which switches between a first path connecting the polarization beam combiner 16 with the antenna 19 and a second path connecting the power combiner 17 with the antenna; and a processing unit that switches the switch circuit based on a reception power so as to switch between connection to the first path and the second path.

Thus, according to the present embodiment, for example, when the reception power increases or decreases due to the weather, control can be implemented in accordance with the weather conditions, without lowering the availability, by switching between connecting the polarization beam combiner 16 and connecting the power combiner 17.

### [Example of Configuration of Wireless Communication Apparatus]

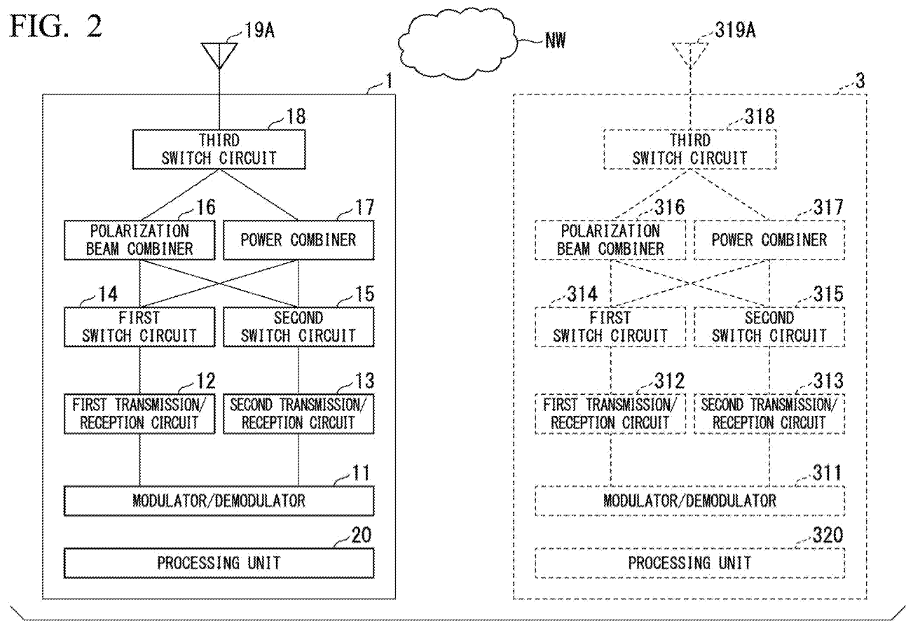

FIG. 2 is a diagram depicting an example of the configuration of a wireless communication apparatus according to the present embodiment. As in FIG. 2, the wireless communication apparatus 1 is provided, for example, with a modulator/demodulator 11, a first transmission/reception circuit 12, a second transmission/reception circuit 13, a first switch circuit 14 (switch circuit), a second switch circuit 15 (switch circuit), a polarization beam combiner 16, a power combiner 17, a third switch circuit 18 (switch circuit), an antenna 19A, and a processing unit 20. The configuration example depicted in FIG. 2 is merely one possible example, and the configuration is not limited thereto. For example, the configuration of the wireless communication apparatus 3 that is the communication partner may be different from the configuration of the wireless communication apparatus 1. Additionally, the number of the wireless communication apparatuses 3 that are the communication partners may be two or more.

The modulator/demodulator 11 functions as a modulator for generating a modulated signal for transmission and functions as a demodulator for reception. The modulator/demodulator 11 may, for example, be provided with two modulator/demodulators. The two modulator/demodulators are, for example, a first modulator/demodulator for the first transmission/reception circuit 12 and a second modulator/demodulator for the second transmission/reception circuit 13.

The first transmission/reception circuit 12 is a frequency converter for high-frequency signals. The first transmission/reception circuit 12 is connected to the modulator/demodulator 11 and the first switch circuit 14. The first transmission/reception circuit 12 converts signals modulated by the modulator/demodulator 11 to high-frequency signals, or converts the frequency of high-frequency signals in order to input the signals to the demodulator of the modulator/demodulator 11. Aside from the frequency converter, the first transmission/reception circuit 12 is also provided with a duplexer for separating transmission/reception signals into transmission and reception.

The second transmission/reception circuit 13 is a frequency converter for high-frequency signals. The second transmission/reception circuit 13 is connected to the modulator/demodulator 11 and the first switch circuit 15. The second transmission/reception circuit 13 converts signals modulated by the modulator/demodulator 11 to high-frequency signals, or converts the frequency of high-frequency signals in order to input the signals to the demodulator of the modulator/demodulator 11. Aside from the frequency converter, the second transmission/reception circuit 13 is also provided with a duplexer for separating transmission/reception signals into transmission and reception.

The first switch circuit 14 is connected to the first transmission/reception circuit 12, the polarization beam combiner 16, and the power combiner 17. The first switch circuit 14 is a switch circuit that functions as a signal switching circuit to the polarization beam combiner 16 and the power combiner 17, with the first transmission/reception circuit 12 as a common port.

The second switch circuit 15 is connected to the second transmission/reception circuit 13, the polarization beam combiner 16, and the power combiner 17. The second switch circuit 15 is a switch circuit that functions as a signal switching circuit to the polarization beam combiner 16 and the power combiner 17, with the second transmission/reception circuit 13 as a common port.

The polarization beam combiner 16 is connected to the first switch circuit 14, the second switch circuit 15, and the third switch circuit 18. The polarization beam combiner 16 is an OMT (Ortho-Mode Transducer) and is used for multiplexed transmission of polarized waves.

The power combiner 17 is connected to the first switch circuit 14, the second switch circuit 15, and the third switch circuit 18. The power combiner 17 is a hybrid device that can be either a combiner or a duplexer. The power combiner 17 functions as a combiner on the transmission side and functions as a duplexer on the reception side.

The third switch circuit 18 is a switch circuit that is connected to the antenna 19A, the polarization beam combiner 16, and the power combiner 17. The third switch circuit 18 functions as a switch circuit to the polarization beam combiner 16 and the power combiner 17, with the antenna 19A as a common port.

The antenna 19A is an antenna that transmits and receives high-frequency signals. In this embodiment, the case in which it is a frequency-division duplex (FDD) antenna will be explained.

The processing unit 20 switches the switch circuits (first switch circuit 14, second switch circuit 15, third switch circuit 18) so as to switch between transmission and reception on the first transmission/reception circuit 12 and the second transmission/reception circuit 13, switches the modulator/demodulator between modulation and demodulation, etc. The processing unit 20 monitors the reception power in the local station. The processing unit 20 checks whether or not communication errors have occurred. The processing unit 20, based on the reception power in the local station, switches the local station from the polarization beam combiner 16 to the power combiner 17, or switches from the power combiner 17 to the polarization beam combiner 16. The processing unit 20, based on the reception power in the local station, generates instructions to be transmitted to communication partners and transmits the generated instructions to the communication partners. The transmission instructions include transmission power change instructions, instructions for switching from the polarization beam combiner 16 to the power combiner 17, or instructions for switching from the power combiner 17 to the polarization beam combiner 16.

### [Example of Configuration of Wireless Communication System]

Next, an example of the configuration of the wireless communication system will be explained by using FIG. 2.

The wireless communication system is provided with, for example, two wireless communication apparatuses (first wireless communication apparatus 1, second wireless communication apparatus 3). The first wireless communication apparatus 1 and the second wireless communication apparatus 3 transmit and receive signals over a network NW.

The configuration of the second wireless communication apparatus 3 is similar to that of the first wireless communication apparatus 1. The processing unit 320, in accordance with instructions from the first wireless communication apparatus 1, controls the transmission power, transmits outputs of the second wireless communication apparatus 3, switches between the first path and the second path, and the like.

### [Brief Explanation of Operations as Transmission Apparatus]

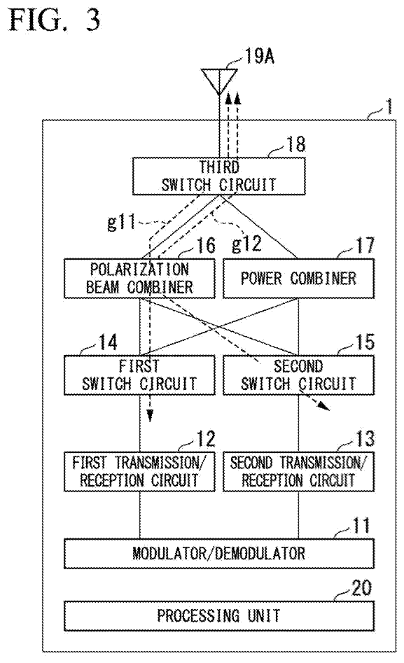

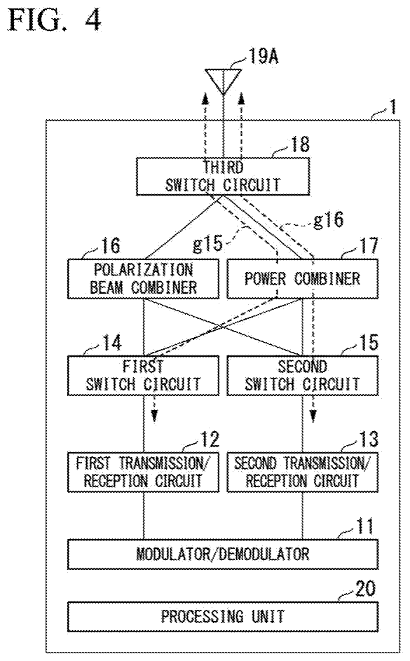

Next, the case in which the wireless communication apparatus 1 operates as a transmission apparatus will be explained with reference to FIGS. 3 and 4. Under all conditions, the first transmission/reception circuit 12 and the second transmission/reception circuit 13 operate simultaneously.

First, the case in which the communication quality is adequately maintained and satisfied when the weather conditions are clear will be explained. FIG. 3 is a diagram for explaining the case in which the wireless communication apparatus operates as a transmission apparatus during clear weather.

In this state, the first switch circuit 14 and the second switch circuit 15 operate on the first path using the polarization beam combiner 16, as indicated by the arrows g11 and g12. High-frequency signals arriving at the antenna 19 via the third switch circuit 18 are polarization beam combined. In this embodiment, the path connecting the polarization beam combiner 16 with the antenna 19A is referred to as the first path.

Next, the case in which the communication quality is not adequately maintained and not satisfied when the weather conditions include rain will be explained. FIG. 4 is a diagram for explaining the case in which the wireless communication apparatus operates as a transmission apparatus.

In this state, the first switch circuit 14 and the second switch circuit 15 operate on the second path using the power combiner 17, as indicated by the arrows g15 and g16. Then, high-frequency signals arriving at the antenna 19 via the third switch circuit 18 are power combined. In this embodiment, the path connecting the power combiner 17 with the antenna 19A is referred to as the second path.

In the case in which the wireless communication apparatus 1 operates as a reception apparatus, the operations are the reverse of those of the transmission apparatus.

By switching the connected paths in this way, according to the present embodiment, during rainy weather, an output power that is, for example, 3 dB higher can be obtained by power combination, without reducing the number of modulation levels and the signal bandwidth per polarization in comparison with those during clear weather.

### [Switch Processing Procedure]

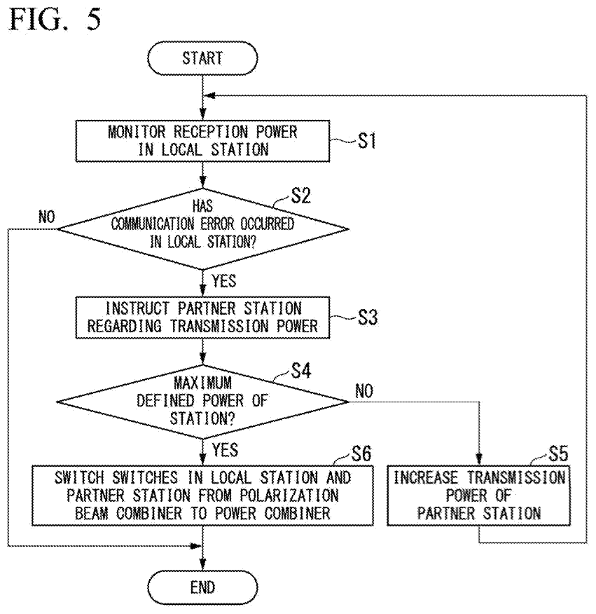

First, an example of the processing procedure when clear weather has changed to rainy weather will be explained. FIG. 5 is a flow chart of the processing procedure when clear weather has changed to rainy weather according to the present embodiment. In the explanation below, an example of bi-directional one-to-one communication when a wireless communication apparatus 1 (first wireless communication apparatus) communicates with another wireless communication apparatus (second wireless communication apparatus) will be explained. Additionally, the configuration of the wireless communication apparatus (second wireless communication apparatus) that is the communication partner will be assumed to be the same as that of the wireless communication apparatus 1.

(Step S1) The processing unit 20 monitors the reception power at the local station (first wireless communication apparatus).

(Step S2) The processing unit 20 determines whether or not a communication error has occurred in the local station. If a communication error has occurred in the local station (step S2: YES), then the processing unit 20 advances the process to step S3. If a communication error has not occurred in the local station (step S2: NO), then the processing unit 20 ends the process.

(Step S3) If an error has occurred, i.e., if the reception power has decreased due to rain, then the processing unit 20 issues an instruction to increase the transmission power to the partner station (second wireless communication apparatus).

(Step S4) The processing unit 20 determines whether or not the partner station is currently set to the maximum power under the apparatus specifications. If the maximum power is set (step S4: YES), then the processing unit 20 advances the process to step S5. If the maximum power is not set (step S4: YES), then the processing unit 20 advances the process to step S6.

(Step S5) Since the transmission power is not maximized in the partner station, the processing unit 20 issues an instruction to increase the transmission power to the partner station. After the process, the processing unit 20 returns to the processing step S1.

(Step S6) Since the transmission power is maximized in the partner station, the processing unit 20 issues instructions to the local station and to the partner station to switch the switch circuits (first switch circuit 14, second switch circuit 15, third switch circuit 18) from the polarization beam combiner 16 to the power combiner 17. At this time, the processing unit 20 may use just one of the respective modulator/demodulators for the first transmission/reception circuit 12 and the second transmission/reception circuit 13.

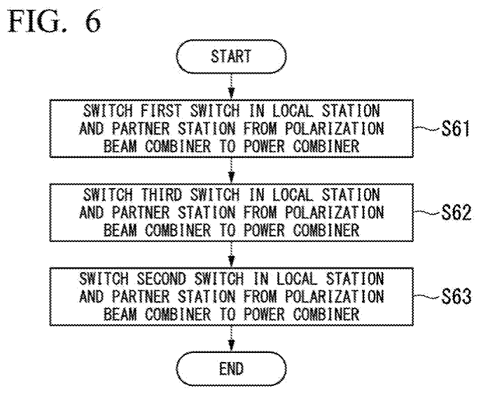

Next, an example of the switch processing procedure for the switch circuits in step S6 in FIG. 5 will be explained. FIG. 6 is a flow chart of the switch processing procedure in the switch circuits when clear weather has changed to rainy weather according to the present embodiment.

(Step S61) The processing unit 20 switches one of the polarizations from the polarization beam combiner 16 to the power combiner 17 with the first switch circuit 14. In this state, it means that the first transmission/reception circuit 12 is not in the communication state and the second transmission/reception circuit 13 is in the communication state.

(Step S62) The processing unit 20 switches one of the polarizations from the polarization beam combiner 16 to the power combiner 17 with the third switch circuit 18. In this state, it means that the first transmission/reception circuit 12 is in the communication state and the second transmission/reception circuit 13 is not in the communication state.

(Step S62) The processing unit 20 switches one of the polarizations from the polarization beam combiner 16 to the power combiner 17 with the second switch circuit 15. In this state, it means that both of the first transmission/reception circuit 12 and the second transmission/reception circuit 13 are in the communication state.

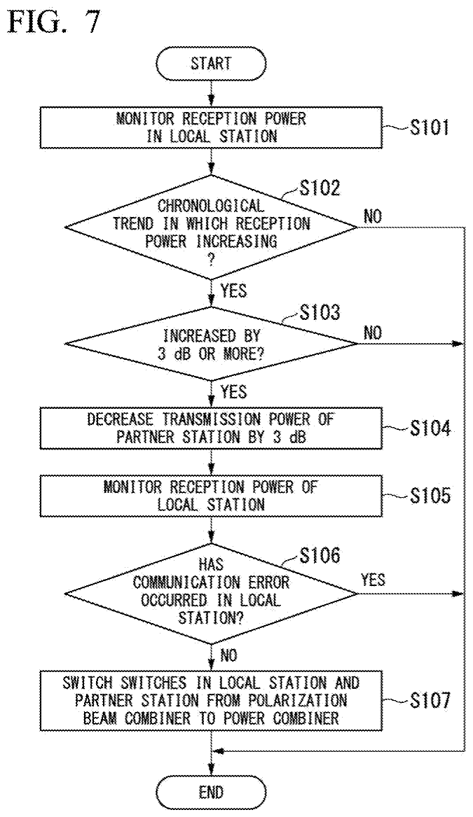

Next, an example of the processing procedure when rainy weather changes to clear weather will be explained. FIG. 7 is a flow chart of the processing procedure when rainy weather has changed to clear weather in the present embodiment.

(Step S101) The processing unit 20 monitors the reception power at the local station.

(Step S102) The processing unit 20 determines whether or not there is a chronological trend in which the reception power is increasing. The result of this process is used to determine whether or not the weather status has changed. If there is a chronological trend in which the reception power is increasing (step S102: YES), then the processing unit 20 advances to the process to step S103. If there is not a chronological trend in which the reception power is increasing (step S102: NO), then the processing unit 20 ends the process.

(Step S103) The processing unit 20 determines whether or not the reception power has increased by a prescribed value (for example, 3 dB) or more. If the reception power has increased by the prescribed value (for example, 3 dB) or more (step S103: YES), then the processing unit 20 advances the process to step S104. If the reception power has not increased by 3 dB or more (step S103: NO), then the processing unit 20 ends the process.

(Step S104) Since the reception power was determined to have increased by the prescribed value (for example, 3 dB) or more, the processing unit 20 instructs the partner station to decrease the transmission power by a prescribed value (for example, 3 dB).

(Step S105) The processing unit 20 monitors the reception power at the local station.

(Step S106) The processing unit 20 determines whether or not a communication error has occurred in the local station. If a communication error has occurred in the local station (step S106: YES), then the processing unit 20 ends the process. If a communication error has not occurred in the local station (step S106: NO), then the processing unit 20 advances the process to step S107.

(Step S107) The processing unit 20 issues instructions to the local station and to the partner station to switch the switch circuits (first switch circuit 14, second switch circuit 15, third switch circuit 18) from the power combiner 17 to the polarization beam combiner 16. If just one of the respective modulator/demodulators for the first transmission/reception circuit 12 and the second transmission/reception circuit 13 is used, then the modulator/demodulators 11 for both the first transmission/reception circuit 12 and the second transmission/reception circuit 13 are used, respectively, at the time of this switch.

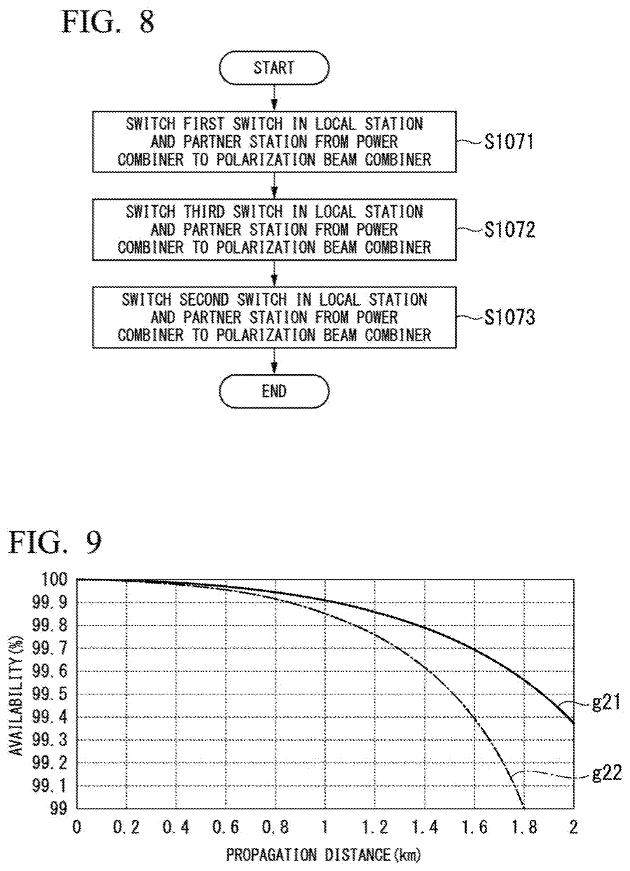

Next, an example of the switch processing procedure for the switch circuits in step S107 in FIG. 7 will be explained. FIG. 8 is a flow chart of the switch processing procedure in the switch circuits when rainy weather has changed to clear weather according to the present embodiment.

(Step S1071) The processing unit 20 switches one of the polarizations from the power combiner 17 to the polarization beam combiner 16 with the first switch circuit 14. In this state, it means that the first transmission/reception circuit 12 is not in the communication state and the second transmission/reception circuit 13 is in the communication state.

(Step S1072) The processing unit 20 switches one of the polarizations from the power combiner 17 to the polarization beam combiner 16 with the third switch circuit 18. In this state, it means that the first transmission/reception circuit 12 is in the communication state and the second transmission/reception circuit 13 is not in the communication state.

(Step S1072) The processing unit 20 switches one of the polarizations from the power combiner 17 to the polarization beam combiner 16 with the second switch circuit 15. In this state, it means that both of the first transmission/reception circuit 12 and the second transmission/reception circuit 13 are in the communication state.

As described above, the wireless communication apparatus 1 of the present embodiment is provided with: an antenna 19A that transmits and receives signals; a polarization beam combiner 16 that is connected to the antenna 19 and that performs multiplexed transmission of polarized waves; a power combiner 17 that is connected to the antenna 19A, that functions as a combiner during transmission and that functions as a duplexer during reception; a switch circuit (first switch circuit 14, second switch circuit 15) to which a reception signal is input during transmission, from which a reception signal is output during reception, and which switches between a first path connecting the polarization beam combiner 16 with the antenna 19A and a second path connecting the power combiner 17 with the antenna 19A; and a processing unit 20 that switches the switch circuit based on a reception power so as to switch between connection to the first path and the second path.

Furthermore, the wireless communication apparatus 1 of the present embodiment is provided with a first transmission/reception circuit 12 that transmits and receives signals, a second transmission/reception circuit 13 that transmits and receives signals, and a modulator/demodulator 11 that modulates transmission signals and demodulates reception signals. The switch circuit is provided with a first switch circuit 14 and a second switch circuit 15. The first switch circuit 14 is connected to the first transmission/reception circuit 12, the polarization beam combiner 16, and the power combiner 17. The second switch circuit 15 is connected to the second transmission/reception circuit 13, the polarization beam combiner 16, and the power combiner 17. The processing unit 20 switches between the first switch circuit 14 and the second switch circuit 15 based on the reception power.

Furthermore, the wireless communication apparatus 1 of the present embodiment is provided with a third switch circuit 18 connected to the antenna 19A, the polarization beam combiner 16, and the power combiner 17. The processing unit 20 switches the third switch circuit 18 based on the reception power.

Additionally, in the wireless communication apparatus 1 of the present embodiment, the processing unit 20 switches the switch circuit from the polarization beam combiner 16 to the power combiner 17 if the reception power in the local station (first wireless communication apparatus 1) has decreased, and if a partner station (second wireless communication apparatus 3) of a communication partner is currently set to a maximum power under apparatus specifications; switches the switch circuit from the power combiner 17 to the polarization beam combiner 16 if there is a chronological trend in which the reception power is increasing and the reception power has increased by a prescribed value or more, and if a communication error has not occurred in the local station; when switching the switch circuit connection from the polarization beam combiner 16 to the power combiner 17, switches the first switch circuit 14 connection from the polarization beam combiner 16 to the power combiner 17, then switches the third switch circuit 18 connection from the polarization beam combiner 16 to the power combiner 17, and switches the second switch circuit 15 connection from the polarization beam combiner 16 to the power combiner 17; and when switching the switch circuit connection from the power combiner 17 to the polarization beam combiner 16, switches the first switch circuit 14 connection from the power combiner 17 to the polarization beam combiner 16, then switches the third switch circuit 18 connection from the power combiner 17 to the polarization beam combiner 16, and switches the second switch circuit 15 connection from the power combiner 17 to the polarization beam combiner 16.

### [Evaluation Results]

Next, an example of results obtained by using the apparatus and the techniques in the above-mentioned embodiment to perform propagation tests will be explained.

In the evaluation, calculations were made under apparatus specifications in which propagation tests were actually performed in the D band (130-174.8 GHz). In this case, the availability with respect to the propagation distance was calculated in two patterns, when using the power combiner 17 and the polarization beam combiner 16. In the calculation of the availability, parameters with the expected rainfall in respective geographical areas as Rain-zone, as indicated by ITU-R P.837-7 (published in June 2017) were used. In this case, parameters in which rainfall with an hourly rate of 0.01% was 90 mm/hr were used.

FIG. 9 is a diagram indicating an example of evaluation results for the present embodiment. In FIG. 9, the horizontal axis represents the propagation distance (km) and the vertical axis represents the availability (%). The line g21 indicates the evaluation results using the power combiner 17 and the line g22 indicates the evaluation results using the polarization beam combiner 16.

From FIG. 9, it can be understood that, by using the power combiner 17, the power-combined 3 dB transmission power is higher than that obtained when using the polarization beam combiner 16 when viewed at the same propagation distance. For example, for maintaining 99.9% availability, the channel design can be extended from 0.8 km to 1.0 km. In other words, in the case where a channel is designed at 0.8 km, the availability increases from 99.9% to 99.95%.

As described above, in the present embodiment, the polarization beam combiner 16 and the power combiner were switched in correspondence with weather conditions.

Thus, according to the present embodiment, output power that is, for example, 3 dB higher can be obtained by power combination without reducing the number of modulation levels and the signal bandwidth per polarization during rainy weather in comparison with those during clear weather.

Generally, the parameters required for high-capacity transmission include the bandwidth occupied by the signals and the number of modulation levels of the modulated signals. Additionally, in the case in which high-capacity communication quality is required in all weather conditions, it is required to provide a system without lowering the communication capacity per polarization. Thus, in general, it is required to design propagation distances to be short in order to ensure the availability in the system. Alternatively, in general, it is required to sacrifice the communication capacity in accordance with the weather conditions in order to maintain the propagation distance.

### (Modified Example)

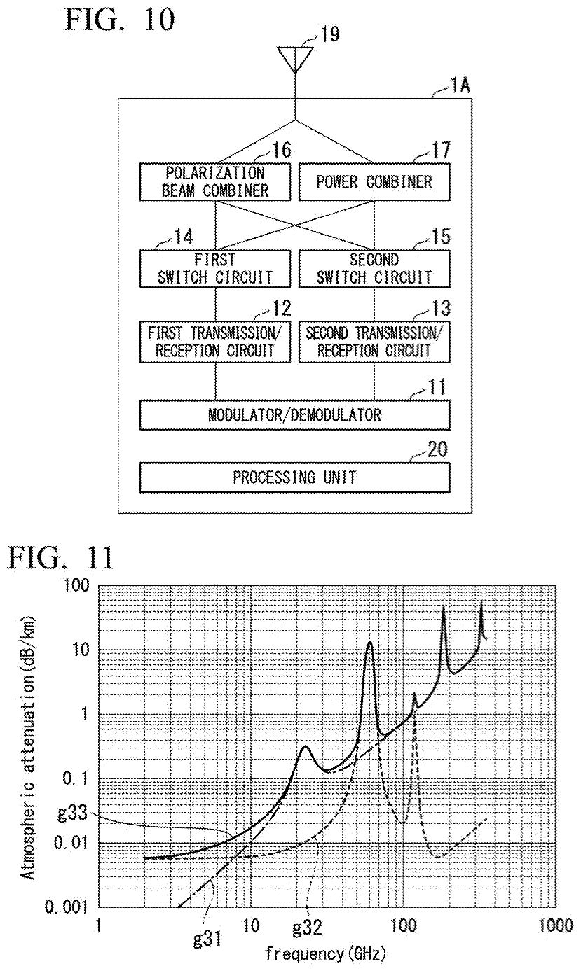

The wireless communication apparatus 1 described above was provided with a third switch circuit 18. However, the wireless communication apparatus does not require to be provided with the third switch circuit 18. FIG. 10 is a diagram depicting an example of the configuration of the wireless communication apparatus according to a modified example. As in FIG. 10, the wireless communication apparatus 1A is provided with, for example, a modulator/demodulator 11, a first transmission/reception circuit 12, a second transmission/reception circuit 13, a first switch circuit 14, a second switch circuit 15, a polarization beam combiner 16, a power combiner 17, an antenna 19, and a processing unit 20. The configuration example depicted in FIG. 10 is merely one possible example, and the configuration is not limited thereto.

The polarization beam combiner 16 is connected to the first switch circuit 14, the second switch circuit 15, and the antenna 19A. The polarization beam combiner 16 is an OMT (Ortho-Mode Transducer), and is used for multiplexed transmission of polarized waves.

The power combiner 17 is connected to the first switch circuit 14, the second switch circuit 15, and the antenna 19A. The power combiner 17 is a hybrid device that can be either a combiner or a duplexer. The power combiner 17 functions as a combiner on the transmission side and functions as a duplexer on the reception side.

The antenna 19 is provided with two ports as inputs/outputs to/from the polarization beam combiner 16 and the power combiner 17.

According to the configuration of this modified example, the process in step S62 in the case in which clear weather has changed to rainy weather (FIG. 6) and the process in step S1072 in the case in which rainy weather has changed to clear weather (FIG. 8) can be omitted. According to this modified example, momentary interruptions in communication can be avoided as much as possible.

Thus, the wireless communication apparatus 1A of the modified example is provided with an antenna 19 that transmits and receives signals; a polarization beam combiner 16 that is connected to the antenna 19 and that performs multiplexed transmission of polarized waves; a power combiner 17 that is connected to the antenna 19, that functions as a combiner during transmission and that functions as a duplexer during reception; a switch circuit (first switch circuit 14, second switch circuit) to which a transmission signal is input during transmission, from which a reception signal is output during reception, and which switches between a first path connecting the polarization beam combiner 16 with the antenna 19 and a second path connecting the power combiner 17 with the antenna 19; and a processing unit 20 that switches the switch circuit based on a reception power so as to switch between connection to the first path and the second path.

Furthermore, the wireless communication apparatus 1A of the present embodiment is provided with a first transmission/reception circuit 12 that transmits and receives signals, a second transmission/reception circuit 13 that transmits and receives signals, and a modulator/demodulator 11 that modulates transmission signals and demodulates reception signals. The switch circuit is provided with a first switch circuit 14 and a second switch circuit 15. The first switch circuit 14 is connected to the first transmission/reception circuit 12, the polarization beam combiner 16, and the power combiner 17. The second switch circuit 15 is connected to the second transmission/reception circuit 13, the polarization beam combiner 16, and the power combiner 17. The processing unit 20 switches between the first switch circuit 14 and the second switch circuit 15 based on the reception power.

Additionally, in the wireless communication apparatus 1A of the modified example, the processing unit 20 switches the switch circuit from the polarization beam combiner 16 to the power combiner 17 if, for example, clear weather has changed to rainy weather and the reception power in the local station (first wireless communication apparatus 1A) has decreased, and if a partner station (second wireless communication apparatus 3 (FIG. 2)) of a communication partner is currently set to a maximum power under apparatus specifications; and switches the switch circuit from the power combiner 17 to the polarization beam combiner 16 if, for example, rainy weather has changed to clear weather, there is a chronological trend in which the reception power is increasing and the reception power has increased by a prescribed value or more, and if a communication error has not occurred in the local station.

Additionally, in the wireless communication apparatus 1A of the modified example, the processing unit 20, when switching the switch circuit connection from the polarization beam combiner 16 to the power combiner 17, switches the first switch circuit 14 connection from the polarization beam combiner 16 to the power combiner 17, then switches the second switch circuit 15 connection from the polarization beam combiner 16 to the power combiner 17; and when switching the switch circuit connection from the power combiner 17 to the polarization beam combiner 16, switches the first switch circuit 14 connection from the power combiner 17 to the polarization beam combiner 16, then switches the second switch circuit 15 connection from the power combiner 17 to the polarization beam combiner 16.

### (Principles)

The principles of the wireless communication apparatus according to the embodiments and the modified example will be explained below.

Microwave or millimeter-wave communication apparatuses use a dual-polarization transmission scheme in which signals are transmitted by using radio waves polarized in two orthogonal polarization planes, i.e., vertically polarized waves (V) and horizontally polarized waves (H), in order to provide high-capacity communication or to increase the frequency utilization efficiency.

Since the V-polarized waves and the H-polarized waves use the same frequency in this scheme, if there is any deviation in the orthogonality of the polarization planes in the antennas or in space, then signals may leak from the V-polarized wave to the H-polarized waves, or from the H-polarized waves to the V-polarized waves.

This leakage is referred to as cross-polarization interference, and has a detrimental impact on the transmission quality of signals. In particular, when making combined use of a dual-polarization transmission scheme and a multi-level modulation scheme such as a quadrature amplitude modulation (QAM), there is a significant influence, and interference components are normally removed by using a cross-polarization interference canceller (XPIC) in a modulator/demodulator.

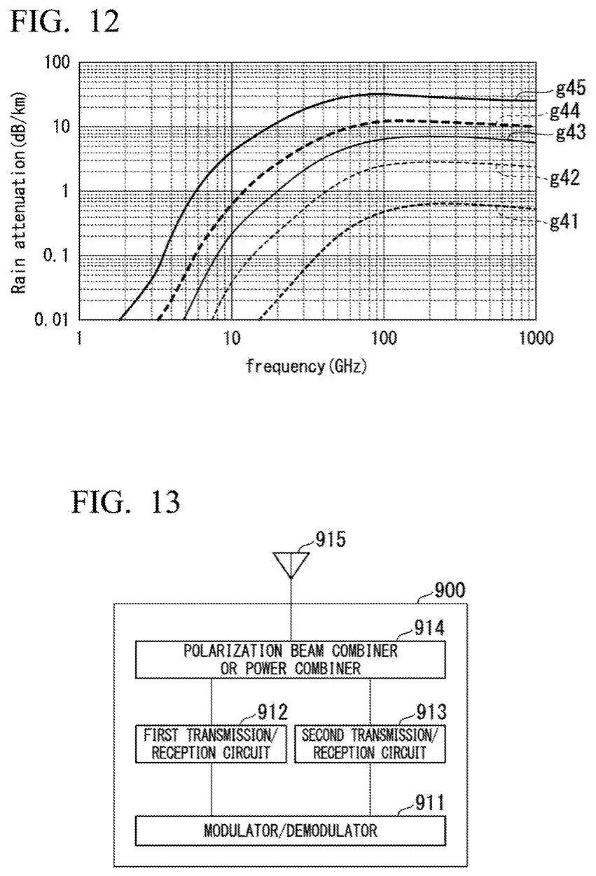

In addition to dual-polarization transmission, use in high-frequency regions in which signal bands can be easily maintained, such as the E band (71-86 GHz), the W band (92-114.5 GHz), and the D band (130-174.8 GHz) has been considered in order to perform high-capacity communication. However, as depicted in FIG. 11 and FIG. 12, from mathematical expressions indicated in ITU-R P.838-3 (published in March 2015), rain attenuation tends to increase as the frequency becomes higher.

FIG. 11 is a diagram indicating an example of atmospheric attenuation indicated by ITU-R P.838-3. In FIG. 11, the horizontal axis represents the frequency (GHz) and the vertical axis represents the atmospheric attenuation (dB/km). The line g31 represents the attenuation by water vapor, the line g32 represents the dry attenuation, and the line g33 represents the sum of attenuation by water vapor and dry attenuation.

FIG. 12 is a diagram indicating an example of rain attenuation indicated by ITU-R P.838-3. In FIG. 11, the horizontal axis represents the frequency (GHz) and the vertical axis represents the rain attenuation (dB/km). The line g41 represents the rainfall rate (0.25 mm/hr), the line g42 represents the rainfall fate (2.5 mm/hr), the line g43 represents the rainfall rate (10 mm/hr), the line g44 represents the rainfall rate (25 mm/hr), and the line g45 represents the rainfall rate (100 mm/hr).

### Comparative Example

FIG. 13 is a diagram indicating an example of the configuration of a wireless communication apparatus of a comparative example, As in FIG. 13, the wireless communication apparatus 900 is provided with, for example, a modulator/demodulator 911, a first transmission/reception circuit 912, a second transmission/reception circuit 913, a polarization beam combiner or a power combiner 914, and an antenna 915.

In a wireless communication apparatus 900 having a configuration as in FIG. 13, when the system is designed for a high frequency band, if the communication quality cannot be adequately maintained and satisfied when the weather conditions are rainy, the propagation distance cannot be made shorter after the wireless communication apparatus has been installed. For this reason, in the comparative example, the number of modulation levels is lowered or the signal bandwidth is made narrower.

In contrast therewith, in the present embodiment, the polarization beam combiner 16 and the power combiner 17 are switched in accordance with the weather. Due to this feature, according to the present embodiment, the system can be provided without lowering the communication capacity per polarization, there is no need to design the propagation distance to be short in order to maintain the availability of the system, and the communication capacity is not sacrificed in accordance with the weather conditions in order to maintain the propagation distance.

The above-mentioned processing unit 20 may have a computer system therein. Furthermore, a program for making the processing unit 20 perform the respective processes mentioned above may be stored in a computer-readable storage medium in the processing unit 20, and the computer in the processing unit 20 may read out and execute this program to perform the above-mentioned processes. In this case, the computer-readable recording medium refers to a magnetic disc, a magneto-optic disc, a CD-ROM, a DVD-ROM, a semiconductor memory, or the like. Additionally, this computer program may be transmitted to a computer over a communication line and the computer that has received this transmission may execute said program.

Additionally, the above-mentioned program may be for realizing just some of the aforementioned functions of the respective processing units. Furthermore, it may be a so-called difference file (difference program) that can realize the aforementioned functions by being combined with a program that is already recorded in the computer system.

The computer system of the processing unit 20 may be provided with, for example, a CPU (central processing unit), a main storage apparatus, an auxiliary storage apparatus, an interface, and a non-volatile recording medium. The CPU may perform the processes performed by the processing unit 20 in accordance with a program.

As mentioned above, the technology described in Patent Document 1 has been disclosed. However, with the technology described in Patent Document 1, the propagation distance required to be designed to be short in order to maintain the availability in the system. Additionally, with the technology described in Patent Document 1, the communication capacity is required to be sacrificed in accordance with the weather conditions in order to maintain the propagation distance.

According to the present disclosure, for example, control can be implemented in accordance with the weather conditions without lowering the availability.

While the present embodiment has been explained in detail by referring to the drawings, the specific configuration is not limited to this embodiment, and designs and the like within a range not departing from the spirit of this embodiment are also included.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. A wireless communication apparatus comprising:
an antenna that transmits and receives signals;
a polarization beam combiner that is connected to the antenna and that performs multiplexed transmission of polarized waves;
a power combiner that is connected to the antenna, that functions as a combiner when transmitting and that functions as a duplexer when receiving;
a switch circuit to which a transmission signal is input during transmission, from which a reception signal is output during reception, and that switches between a first path connecting the polarization beam combiner with the antenna and a second path connecting the power combiner with the antenna; and
a processor that switches the switch circuit based on a reception power so as to switch between connection to the first path and the second path.

2. The wireless communication apparatus according to claim 1, further comprising:
a first transmission/reception circuit that transmits and receives the signals;
a second transmission/reception circuit that transmits and receives the signals; and
a modulator/demodulator that modulates the transmission signals and demodulates the reception signals; wherein
the switch circuit comprises a first switch circuit and a second switch circuit;
the first switch circuit is connected to the first transmission/reception circuit, the polarization beam combiner, and the power combiner;
the second switch circuit is connected to the second transmission/reception circuit, the polarization beam combiner, and the power combiner; and
the processor switches between the first switch circuit and the second switch circuit based on the reception power.

3. The wireless communication apparatus according to claim 2, further comprising:
a third switch circuit connected to the antenna, the polarization beam combiner, and the power combiner; wherein
the processor switches the third switch circuit based on the reception power.

4. The wireless communication apparatus according to claim 1, wherein
the processor:
switches the switch circuit from the polarization beam combiner to the power combiner if the reception power in a local apparatus has decreased, and if a partner apparatus of a communication partner is currently set to a maximum power under apparatus specifications; and
switches the switch circuit from the power combiner to the polarization beam combiner if there is a chronological trend in which the reception power is increasing and the reception power has increased by a prescribed value or more, and if a communication error has not occurred in the local apparatus.

5. The wireless communication apparatus according to claim 4, wherein
the switch circuit comprises a first switch circuit and a second switch circuit; and
the processor:
when switching the switch circuit connection from the polarization beam combiner to the power combiner, switches the first switch circuit connection from the polarization beam combiner to the power combiner, then switches the second switch circuit connection from the polarization beam combiner to the power combiner; and
when switching the switch circuit connection from the power combiner to the polarization beam combiner, switches the first switch circuit connection from the power combiner to the polarization beam combiner, then switches the second switch circuit connection from the power combiner to the polarization beam combiner.

6. The wireless communication apparatus according to claim 2, wherein
the switch circuit comprises a third switch circuit connected to the polarization beam combiner and the power combiner; and
the processor:
switches the switch circuit connection from the polarization beam combiner to the power combiner if the reception power in a local apparatus has decreased, and if a partner apparatus of a communication partner is currently set to a maximum power under apparatus specifications;
switches the switch circuit connection from the power combiner to the polarization beam combiner if there is a chronological trend in which the reception power is increasing and the reception power has increased by a prescribed value or more, and if a communication error has not occurred in the local apparatus;
when switching the switch circuit connection from the polarization beam combiner to the power combiner, switches the first switch circuit connection from the polarization beam combiner to the power combiner, then switches the third switch circuit connection from the polarization beam combiner to the power combiner, and switches the second switch circuit connection from the polarization beam combiner to the power combiner; and
when switching the switch circuit connection from the power combiner to the polarization beam combiner, switches the first switch circuit connection from the power combiner to the polarization beam combiner, then switches the third switch circuit connection from the power combiner to the polarization beam combiner, and switches the second switch circuit connection from the power combiner to the polarization beam combiner.

7. A wireless communication system comprising:
a first wireless communication apparatus; and
a second wireless communication apparatus connected to first wireless communication apparatus via a network, wherein
the first wireless communication apparatus and the second wireless communication apparatus each comprise
an antenna that transmits and receives signals,
a polarization beam combiner that is connected to the antenna and that performs multiplexed transmission of polarized waves,
a power combiner that is connected to the antenna, that functions as a combiner when transmitting and that functions as a duplexer when receiving,
a switch circuit to which a transmission signal is input during transmission, from which a reception signal is output during reception, and that switches between a first path connecting the polarization beam combiner with the antenna and a second path connecting the power combiner with the antenna, and
a processor that switches the switch circuit based on a reception power so as to switch between connection to the first path and the second path; and
the processor in the first wireless communication apparatus:
issues, to the second wireless communication apparatus, an instruction to increase the transmission power if the reception power in the first wireless communication apparatus has decreased;
issues, to the first wireless communication apparatus and the second wireless communication apparatus, instructions to switch the switch circuit from the polarization beam combiner to the power combiner if the second wireless communication apparatus is currently set to a maximum power under apparatus specifications; and
issues, to the second wireless communication apparatus, an instruction to increase the transmission power if the second wireless communication apparatus is not currently set to the maximum power under apparatus specifications.

8. The wireless communication system according to claim 7, wherein
the processor in the first wireless communication apparatus:
issues an instruction to decrease the transmission power of the second wireless communication apparatus by a prescribed value if there is a chronological trend in which the reception power is increasing and if the reception power has increased by a prescribed value or more; and
issues, to the first wireless communication apparatus and the second wireless communication apparatus, instructions to switch the switch circuit connection from the power combiner to the polarization beam combiner if a communication error has not occurred in a local apparatus.

9. A wireless communication control method performed by a wireless communication apparatus comprising
an antenna that transmits and receives signals,
a polarization beam combiner that is connected to the antenna and that performs multiplexed transmission of polarized waves,
a power combiner that is connected to the antenna, that functions as a combiner when transmitting and that functions as a duplexer when receiving, and
a switch circuit to which a transmission signal is input during transmission, from which a reception signal is output during reception, and which switches between a first path connecting the polarization beam combiner with the antenna and a second path connecting the power combiner with the antenna;
wherein the wireless communication control method includes
switching the switch circuit based on a reception power so as to switch between connection to the first path and the second path.
